(19) United States
(12) Patent Application Publication
(10) Pub. No.: US 2003/0142648 A1
(43) Pub. Date: Jul. 31, 2003

(54) System and method for providing a continuous high speed packet data handoff

(75) Inventor: William Joseph Semper, Richardson, TX (US)

Correspondence Address: Docket Clerk, P.O. Drawer 800889, Dallas, TX, 75380, US

(73) Assignee: SAMSUNG ELECTRONICS Co., LTD., Suwon-city (KR)

(21) Appl. No.: 10/066,248

(22) Filed: Jan. 31, 2002

(51) Int. Cl. H04J 3/24; H04Q 7/00

(52) U.S. Cl. 370/331; 370/349

(57) ABSTRACT

A system and method is disclosed for providing a continuous high speed packet data handoff for a mobile station in a wireless network. The system comprises a packet data handoff controller in a source base station that is capable of handing off high speed packet data on a supplemental channel. The packet data handoff controller executes a handoff by sending handoff messages that contain supplemental channel configuration information and Radio Link Protocol (RLP) configuration information. The packet data handoff controller activates a non-retransmission mode of the Radio Link Protocol (RLP). The target base station receives the high speed packet data call starting at a selected Radio Link Protocol (RLP) frame.

The present invention is generally directed to wireless telecommunications networks and more particularly to a system and method for providing a continuous high speed packet data handoff for a mobile station in a wireless network.

### BACKGROUND OF THE INVENTION

Wireless communication systems, including cellular phones, paging devices, personal communication services (PCS) systems, and wireless data networks, have become ubiquitous in society. Wireless service providers continually try to create new markets for wireless devices and to expand existing markets by making wireless devices and services cheaper and more reliable. The price of end-user wireless devices, such as cell phones, pagers, PCS systems, and wireless modems, has been driven down to the point where these devices are affordable to nearly everyone and the price of a wireless device is only a small part of the end-user's total cost. To continue to attract new customers, wireless service providers concentrate on reducing infrastructure costs and operating costs, and on increasing handset battery lifetime, while improving quality of service in order to make wireless services cheaper and better.

To maximize usage of the available bandwidth, a number of multiple access technologies have been implemented to allow more than one subscriber to communicate simultaneously with each base station (BS) in a wireless system. These multiple access technologies include time division multiple access (TDMA), frequency division multiple access (FDMA), and code division multiple access (CDMA). These technologies assign each system subscriber to a specific traffic channel that transmits and receives subscriber voice/data signals via a selected time slot, a selected frequency, a selected unique code, or a combination thereof.

CDMA technology is used in wireless computer networks, paging (or wireless messaging) systems, and cellular telephony. In a CDMA system, mobile stations and other access terminals (e.g., pagers, cell phones, laptop PCs with wireless modems) and base stations transmit and receive data on the same frequency in assigned channels that correspond to specific unique orthogonal codes. For example, a mobile station may receive forward channel data signals from a base station that are convolutionally coded, formatted, interleaved, spread with a Walsh code and a long pseudo-noise (PN) sequence. In another example, a base station may receive reverse channel data signals from the mobile station that are convolutionally encoded, block interleaved, modulated by a 64-ary orthogonal modulation, and spread prior to transmission by the mobile station. The data symbols following interleaving may be separated into an in-phase (I) data stream and a quadrature (Q) data stream for QPSK modulation of an RF carrier. One such implementation is found in the TIA/EIA-95 CDMA standard (also known as IS-95). Another implementation is the TIA/EIA-2000 standard (also known as IS-2000).

The current generation of cellular phones is used primarily for voice conversations between a subscriber device (or wireless device) and another party through the wireless network. A smaller number of wireless devices are 20 data devices, such as personal digital assistants (PDAs) equipped with cellular/wireless modems. Because the bandwidth for a current generation wireless device is typically limited to a few tens of kilobits per second (kbps), the applications for the current generation of wireless devices are relatively limited. However, this is expected to change in the next (or third) generation of cellular/wireless technology, sometimes referred to as “3G” wireless/cellular, where much greater bandwidth will be available to each wireless device (i.e., 125 kbps or greater).

The higher data rates will make Internet applications for wireless devices much more common. For instance, a 3G cell phone (or a personal computer (PC) with a 3G cellular modem) may be used to browse web sites on the Internet, to transmit and receive graphics, to execute streaming audio or video applications, and the like. A much higher percentage of the wireless traffic handled by 3G cellular systems will be Internet protocol (IP) traffic and a lesser percentage will be traditional voice traffic.

Real-time streaming of multimedia content over Internet protocol (IP) networks has become an increasingly common application in recent years. As noted above, 3G wireless networks will provide streaming data (both video and audio) to wireless devices for real time applications. A wide range of interactive and non-interactive multimedia Internet applications, such as news on-demand, live TV viewing, video conferencing, live radio broadcasting (such as Broadcast.com), and the like, will provide “real time” data streaming to wireless devices. Unlike a “downloaded” video file, which may be retrieved first in “non-real” time and viewed or played back later, real time (or streaming) data applications require a data source to encode and to transmit a streaming data signal over a network to a receiver, which must decode and play the signal (video or audio) in real time.

As is well known in the art, when a mobile station (e.g., a cellular telephone) moves from a first cell to a second cell the base station for the first cell (the “source” base station) executes a transfer or “hand off” of the mobile station to the base station of the second cell (the “target” base station). A handoff may be either a “soft handoff” or a “hard handoff.” In a “soft handoff” a connection is made between the mobile station and the target base station before the existing connection between the source base station and the mobile station is broken. In a “hard handoff” the existing connection between the source base station and the mobile station is broken before a new connection is made between the mobile station and the target base station.

The existing standards for 3G wireless networks include the IS-2001-A standard and the IS-2001-B standard. These standards provide a protocol called Service Option 33 for a hard handoff of high speed packet data. In existing 3G wireless networks a mobile station maintains a Point-to-Point Protocol (PPP) connection and Mobile Internet Protocol (MIP) connection with a Packet Data Service Node (PDSN). Each base station connects to one or more Packet Data Service Nodes (PDSNs).

When a mobile station is handed off to a new base station (i.e., to a target base station), a new connection must be established to a PDSN. If the PDSN to which the connection is being made is not the PDSN that is currently serving the packet data call, then the PPP connection and the MIP connection must be established again between the new PDSN and the mobile station. Establishing a new PPP connection and a new MIP connection results in degradation of the packet data service.

There is a Fast Handoff feature available in networks that operate in accordance with the IS-2001-B standard. Using the Fast Handoff feature, it is possible to avoid PPP and MIP negotiation on the target base station if the call is to be connected to a new PDSN. This is accomplished by forming a tunnel between the new PDSN and the old PDSN and maintaining the same PPP and MIP states for the mobile station.

A Supplemental Channel (SCH) is capable of data transmission rates of up to one hundred fifty three and six tenths kilobits per second (153.6 kbps). By comparison a Fundamental Channel operates at a data transmission rate of either nine and six tenths kilobits per second (9.6 kbps) or fourteen and four tenths kilobits per second (14.4 kbps).

Due to presently existing limitations in the IS-2001-A standard and in the IS-2001-B standard, it is not possible to hand off a Supplemental Channel. It is possible, however, to hand off a lower data rate Fundamental Channel or a lower data rate Dedicated Control channel. The lower data rate of the Fundamental Channel (usually 14.4 kbps) and the lower data rate of the Dedicated Control Channel (usually 9.6 kbps) limits the data rate that can be handed off to a maximum of fourteen and four tenths kilobits per second (14.4 kpbs).

In presently existing network systems, the data service must be slowed down (or even dropped) when the Supplemental Channel on the source base station is dropped in a hard handoff. After the hard handoff has occurred, the Supplemental Channel must again be re-established on the target base station.

Because the Inter-Operability Specification (IOS) messaging that executes the hard handoff does not request the target base station to received the Supplemental Channel, it is possible that the call can be handed off to a cell that is not capable of supporting high speed packet data (or a Supplemental Channel) at the time of the handoff. If this happens, the data service must be dropped (or at least seriously degraded) after the handoff is complete.

Assume that (1) the mobile station is able to acquire the target base station, and (2) the mobile station is successfully handed off to the new cell, and (3) the target base station is able to re-establish a Supplemental Channel. Even if these events occur, a Radio Link Protocol (RLP) connection must be re-negotiated and re-established on the new cell. Re-establishing a Radio Link Protocol (RLP) connection further delays the resumption of high speed packet data service.

A Radio Link Protocol (RLP) is a protocol that a base station uses when it sends data to a mobile station. In the Radio Link Protocol the base station sends data to the mobile station and then listens for a response from the mobile station. If the mobile station did not receive part of a transmission, the mobile station sends a message back to the base station and requests re-transmission of the missing part of the transmission. The Radio Link Protocol (RLP) provides a mechanism that allows the base station to buffer data that is transmitted to the mobile station. Upon receiving a request from the mobile station, the base station re-transmits a copy of the data that the mobile station did not receive.

The above described limitations of prior art systems have a performance impact on high speed packet data applications that may have high Quality of Service (Qos) requirements (e.g., streaming video). In addition, the above described limitation of the prior art systems make it impossible to execute a hard handoff of high speed circuit data services (e.g., ISDN), because such services require at a minimum a thirty two kilobits per second (32 kbps) uninterrupted circuit connection.

There is, therefore, a need in the art for an improved system and method for providing a continuous high speed packet data handoff for a mobile station in a wireless network.

### SUMMARY OF THE INVENTION

To address the deficiencies of the prior art, it is a primary object of the present invention to provide a system and method for providing a continuous high speed packet data handoff for a mobile station in a wireless network.

The present invention comprises a packet data handoff controller in a source base station that is capable of handing off high speed packet data on a supplemental channel. The present invention also comprises a packet data handoff controller in a target base station that is capable of receiving high speed packet data on a supplemental channel.

The packet data handoff controller in the source base station executes a handoff by sending handoff messages to the target base station that contain supplemental channel configuration information and Radio Link Protocol (RLP) configuration information. The target base station is capable of using this information to determine whether it is able to handle the transmission rate of the high speed packet data. The target base station is also capable of using this information to determine the first Radio Link Protocol (RLP) frame that the target base station will receive after the high speed packet data call has been handed over to the target base station. This feature enables the present invention to immediately resume transmission and reception of RLP frames after a high speed packet data handoff.

The present invention also turns off a retransmission mode of the Radio Link Protocol (RLP) during a high speed packet data handoff. This is because the present invention makes it unnecessary to retransmit Radio Link Protocol (RLP) frames as is done in prior art systems.

It is an object of the present invention to provide a system and method for providing a continuous high speed packet data handoff for a mobile station in a wireless network.

It is also an object of the present invention to provide a system and method for increasing the performance levels of data transmission during a high speed packet data handoff of a mobile station in a wireless network.

It is another object of the present invention to provide an improved system and method for handing off a Supplemental Channel from a source base station to a target base station in a wireless network.

It is another object of the present invention to provide an improved system and method for handing off a Supplemental Channel from a source base station to a target base station during a high speed packet data handoff of a mobile station in a wireless network.

It is another object of the present invention to provide an improved system and method for turning off a retransmission mode of a Radio Link Protocol during a high speed packet data handoff of a mobile station in a wireless network.

It is yet another object of the present invention to provide an improved system and method for providing information to a target base station to enable the target base station to determine in advance whether it can support a high speed packet data call.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary prior art wireless network;

FIG. 2 illustrates an exemplary base station and base transceiver station according to an advantageous embodiment of the present invention;

FIG. 3 illustrates an exemplary high speed packet data handoff of a wireless mobile station according to an advantageous embodiment of the present invention; and

FIG. 4 illustrates a flow chart of an advantageous embodiment of a method of the present invention for providing a continuous high speed packet data handoff for a mobile station in a wireless network.

### DETAILED DESCRIPTION OF THE INVENTION

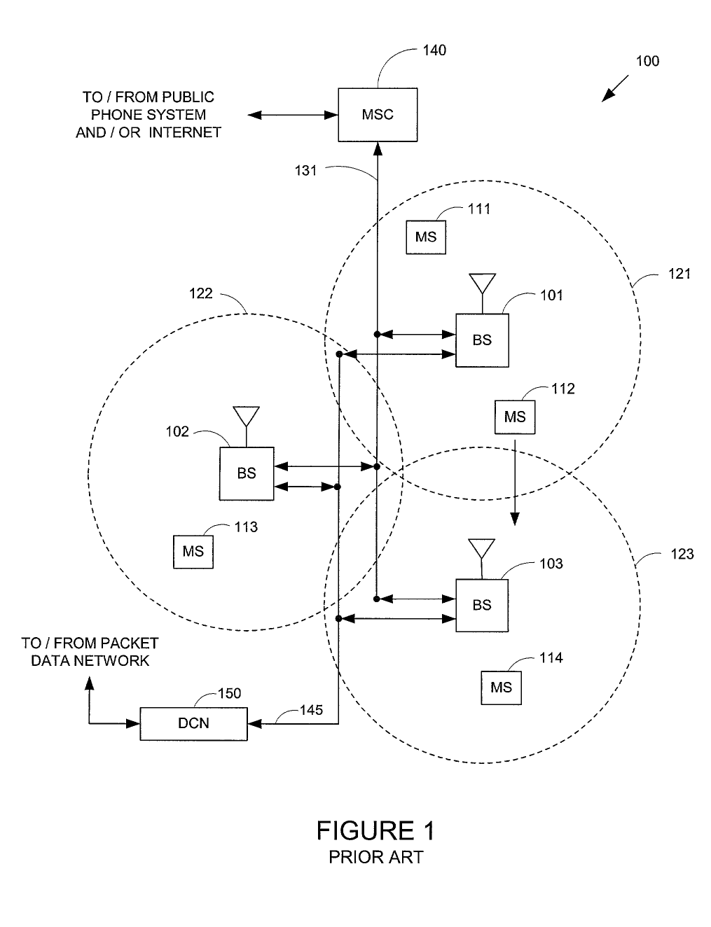

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless telecommunication network.

FIG. 1 illustrates an exemplary prior art wireless network 100. Wireless network 100 comprises a plurality of cell sites 121-123, each containing one of the base stations, BS 101, BS 102, or BS 103. Base stations 101-103 are operable to communicate with a plurality of mobile stations (MS) 111-114. Mobile stations 111-114 may be any suitable wireless communication devices, including conventional cellular telephones, PCS handset devices, portable computers, telemetry devices, and the like, which are capable of communicating with the base stations via wireless links. Other types of access terminals, including fixed access terminals, also may be present in wireless network 100. However, for the sake of simplicity, only mobile stations are shown.

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

Each of the base stations BS 101, BS 102, and BS 103 may comprise a base station controller (3SC) and a base transceiver station (BTS). Base station controllers and base transceiver stations are well known to those skilled in the art. A base station controller is a device that manages wireless communications resources, including the base transceiver station, for specified cells within a wireless communications network. A base transceiver station comprises the RF transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver station in each of cells 121, 122, and 123 and the base station controller associated with each base transceiver station are collectively represented by BS 101, BS 102 and BS 103, respectively.

BS 101, BS 102 and BS 103 transfer voice and data signals between each other and the public telephone system (not shown) via communications line 131 and mobile switching center (MSC) 140. Mobile switching center 140 is well known to those skilled in the art. Mobile switching center 140 is a switching device that provides services and coordination between the subscribers in a wireless network and external networks, such as the public telephone system and/or the Internet. Communications line 131 links each vocoder in the base station controller (BSC) with switch elements in the mobile switching center (MSC) 140. In one advantageous embodiment, each link provides a digital path for transmission of voice signals in the pulse code modulated (PCM) format. Communications line 131 may be any suitable connection means, including a T1 line, a T3 line, a fiber optic link, a network backbone connection, and the like. In some embodiments, communications line 131 may be several different data links, where each data link couples one of BS 101, BS 102, or BS 103 to MSC 140.

BS 101, BS 102 and BS 103 transfer data signals between each other and the Internet or other packet data network (not shown) via communications line 145 and data core network (DCN) server 150. Data core network (DCN) server 150 is well known to those skilled in the art. Data core network (DCN) server 150 is a packet data switching or routing device that provides services and coordination between the subscribers in a wireless network and external packet data networks, such as a corporate Ethernet system and/or the Internet. Those skilled in the art will understand that line 145 interfaces to a packet data serving node (not shown) located in data core network 150. Communications line 145 may be any suitable connection line, including an Ethernet link, a T1 connection, a T3 line, a fiber optic link, a network backbone connection, and the like. In some embodiments, communications line 145 may comprise several different data links, where each data link couples one of BS 101, BS 102, or BS 103 to data core network (DCN) 150.

In the exemplary wireless network 100, MS 111 is located in cell site 121 and is in communication with BS 101, MS 113 is located in cell site 122 and is in communication with BS 102, and MS 114 is located in cell site 123 and is in communication with BS 103. MS 112 is also located in cell site 121, close to the edge of cell site 123. The direction arrow proximate MS 112 indicates the movement of MS 112 towards cell site 123. At some point, as MS 112 moves into cell site 123 and out of cell site 121, a handoff will occur.

As is well known to those skilled in the art, the handoff procedure transfers control of a call from a first cell to a second cell. A handoff may be either a “soft handoff” or a “hard handoff.” In a “soft handoff” a connection is made between the mobile station and the base station in the second cell before the existing connection is broken between the mobile station and the base station in the first cell. In a “hard handoff” the existing connection between the mobile station and the base station in the first cell is broken before a new connection is made between the mobile station and the base station in the second cell.

For example, assume that mobile stations 111-114 communicate with base stations BS 101, BS 102 and BS 103 over code division multiple access (CDMA) channels. As MS 112 moves from cell 121 to cell 123, MS 112 determines that a handoff is required based on detection of a control signal from BS 103, increased bit error rate on signals from BS 101, signal time delay, or some other characteristic. When the strength of the control signal transmitted by BS 103, or the bit error rate of signals received from BS 101, or the round trip time delay exceeds a threshold, BS 101 initiates a handoff process by signaling MS 112 and the target BS 103 that a handoff is required. BS 103 and MS 112 proceed to negotiate establishment of a communications link. The call is thereby transferred from BS 101 to BS 103. An idle handoff is a handoff between cells of a mobile device that is communicating in the control or paging channel, rather than transmitting voice and/or data signals in the regular traffic channels.

One or more of the wireless devices in wireless network 100 may be capable of executing real time applications, such as streaming audio or streaming video applications. Wireless network 100 receives the real time data from, for example, the Internet through data core network (DCN) server 150 and through communications line 145 and transmits the real time data in the forward channel to the wireless device. For example, MS 112 may comprise a 3G cellular phone device that is capable of surfing the Internet and listening to streaming audio, such as music from the web site “www.mp3.com” or a sports radio broadcast from the web site “www.broadcast.com.” MS 112 may also view streaming video from a news web site, such as “www.CNN.com.” To avoid increasing the memory requirements and the size of wireless phone devices, one or more of the base stations in wireless network 100 provides real time data buffers that can be used to buffer real time data being sent to, for example, MS 112.

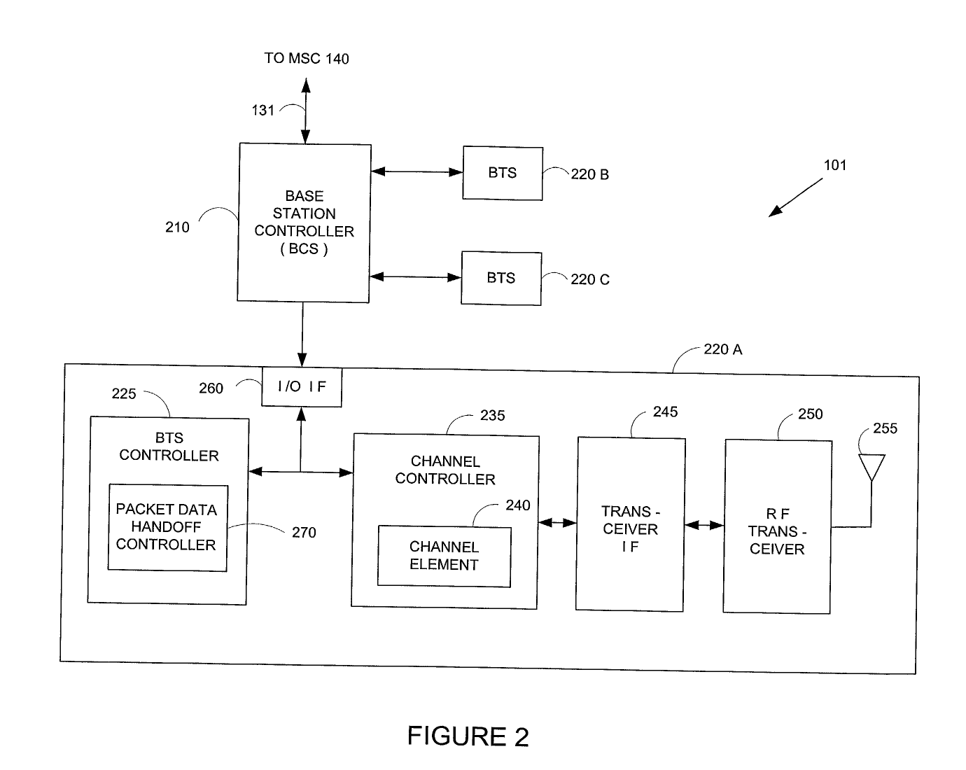

FIG. 2 illustrates exemplary base station 101 and base transceiver station (BTS) 220A according to an advantageous embodiment of the present invention. Base station 101 comprises base station controller (BSC) 210 and base transceiver stations BTS 220A, BTS 220B, and BTS 220C. Base station controllers and base transceiver stations were described previously in connection with FIG. 1.

BSC 210 manages the resources in cell site 121, including BTS 220A, BTS 220B, and BTS 220C. As described above, BSC 210 is coupled to MSC 140 over data communication line 131. Exemplary BTS 220A comprises BTS controller 225, channel controller 235 that contains exemplary channel element 240, transceiver interface (IF) 245, RF transceiver unit 250, and antenna array 255. Input/output interface (I/O IF) 260 couples BTS 220A to BSC 210.

BTS controller 225 controls the overall operation of BTS 220A and interfaces with BSC 210 through I/O IF 260. BTS controller 225 directs the operation of channel controller 235. Channel controller 235 contains a number of channel elements such as channel element 240. The channel elements perform bi-directional communications in the forward and reverse links. Depending on the air interface used by the system of BS 101, the channel elements engage in time division multiple access (TDMA), frequency division multiple access (FDMA), or code division multiple access (CDMA) communications with the mobile stations in cell 121.

Transceiver IF 245 transfers the bi-directional channel signals between channel controller 235 and RF transceiver 250. Transceiver IF 245 converts the radio frequency signal from RF transceiver 250 to an intermediate frequency (IF). Channel controller 235 then converts this intermediate frequency (IF) to baseband frequency. Additionally, RF transceiver 250 may contain an antenna selection unit to select among different antennas in antenna array 255 during both transmit and receive operations.

Antenna array 255 is comprised of a number of directional antennas that transmit forward link signals, received from RF transceiver 250, to mobile stations in the sectors covered by BS 101. Antenna array 255 also receives reverse link signals from the mobile stations and sends the signals to RF transceiver 250. In a preferred embodiment of the present invention, antenna array 255 is a multisector antenna, such as a six-sector antenna, in which each antenna is responsible for transmitting and receiving in a sixty degree (600) arc of coverage area.

BS 101 of the present invention is not limited to the architecture described above. The architecture may be different depending on the type of air interface standard used by the wireless system. Additionally, the present invention is not limited by the frequencies used. Different air interface standards require different frequencies.

In an advantageous embodiment of the present invention, BTS controller 225 comprises a microprocessor (also known as a microcontroller) and a memory unit. The microprocessor and memory unit of BTS controller 225 are not shown in FIG. 2. BTS controller 225 is capable of executing software applications stored in the memory unit. BTS controller 225 also comprises packet data handoff controller 270. As will be more fully described, packet data handoff controller 270 is capable of carrying out the present invention.

The packet data handoff messages of the present invention are handled in base station 101 in packet data handoff controller 270 of BTS controller 225. Packet data handoff controller 270 prepares packet data handoff messages to be transmitted by base station 101. Packet data handoff controller 270 also interprets incoming packet data handoff messages from mobile station 112 and mobile switching center (MSC) 140. Packet data handoff controller 270 coordinates the establishment of a continuous high speed packet data handoff of mobile station 112 to base station 103. The BTS controller (not shown) of base station 103 also comprises a similar packet data handoff controller (not shown).

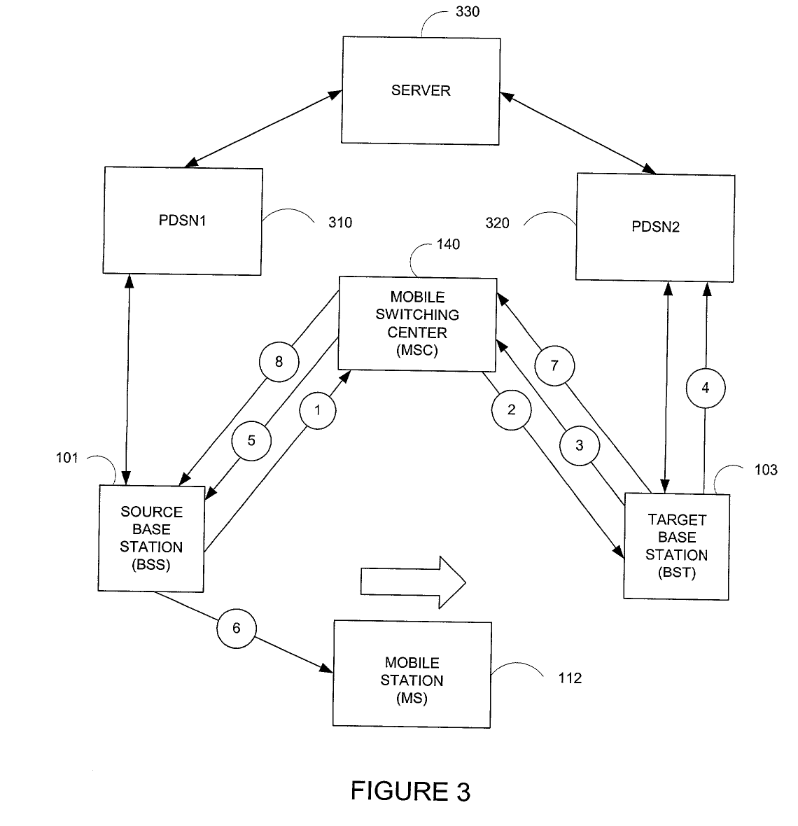

FIG. 3 illustrates an exemplary high speed packet data handoff according to an advantageous embodiment of the present invention. Base station 101 is a source base station (denoted BSS) in communication with mobile station (MS) 112. Mobile Station (MS) 112 is in motion away from base station 101 towards base station 103. Base station 103 is a target base station target (denoted BST) that will receive the handoff of MS 112 from source base station 101. BSS 101 and BST 103 are both in communication with mobile switching center (MSC) 140. BSS 101 is in communication with a first Packet Data Service Node (PDSN1) 310. BST 103 is in communication with a second Packet Data Service Node (PDSN2) 320. Each of the two Packet Data Service Nodes, PDSN1 310 and PDSN2 320, are in communication with server 330.

Assume that MS 112 is engaged in a high speed packet data call with BSS 101 using a Supplemental Channel (SCH). In accordance with the principles of the present invention, the Radio Link Protocol (RLP) is set to operate in a non-retransmission mode. That is, packet data handoff controller 270 in source base station (BSS) 101 sets the value of NUM_ROUNDS in the Radio Link Protocol (RLP) equal to zero to ensure that no retransmissions are made.

The circled numeral one (1) on an arrow from BSS 101 to MSC 140 indicates the next step in the method of the present invention. BSS 101 determines that MS 112 needs to be handed off to EST 103. BSS 101 makes this determination by conventional means (e.g., by receiving a Pilot Strength Measurement Message from MS 112). BSS 101 then sends a Handoff Required message to MSC 140.

The Handoff Required message is based on the IS-2001-A standard. However, in accordance with the principles of the present invention, the Handoff Required message also contains information about the configuration of the Supplemental Channel (SCH) that is being used by MS 112. In particular, the Handoff Required message contains the following information about the Supplemental Channel (SCH) configuration: (1) the assigned SCH forward data rate, (2) the assigned SCH reverse data rate, (3) the assigned SCH burst duration, and (4) the assigned SCH Radio Configuration.

In accordance with the principles of the present invention, the Handoff Required message contains an indication that MS 112 is using the Radio Link Protocol (RLP) in a non-retransmission mode.

The Handoff Required message also contains information concerning the Radio Link Protocol (RLP) configuration. The Radio Link Protocol (RLP) uses certain RLP parameters to identify RLP frames that are being transmitted and received. In particular, the value of a quantity L_V(S) identifies a twelve (12) bit sequence number of the next data frame to be supplied to the multiplex sublayer, and the value of a quantity L_V(R) identifies a twelve (12) bit sequence number of the next expected data frame, and the value of a quantity L_V(N) identifies a twelve (12) bit sequence number of the next data frame needed for sequential delivery.

In addition, the Radio Link Protocol (RLP) uses certain extended RLP parameters EXT_L_V(S), EXT_L_V(R), and EXT_L_V(N) in order to identify thirty (30) bit extended versions of L_V(S), L_V(R), and L_V(N). The RLP parameters and the extended RLP parameters are defined in the IS-707-A-2.10 Standard and are well known in the art.

The Handoff Required message contains the following information about the Radio Link Protocol (RLP) configuration: (1) an indication of whether or not the Radio Link Protocol (RLP) is using encryption, (2) the expected value of L_V(S) at the time the handoff will occur, (3) the expected value of L_V(N) at the time the handoff will occur, (4) the expected value of L_V(R) at the time the handoff will occur, (5) the expected value of EXT_L_V(S) at the time the handoff will occur, (6) the expected value of EXT_L_V(N) at the time the handoff will occur, and (7) the expected value of EXT_L_V(R) at the time the handoff will occur.

The circled numeral two (2) on an arrow from MSC 140 to BST 103 indicates the next step in the method of the present invention. MSC 140 sends a Handoff Request message to BST 103 to request a handoff of the high speed packet data call to the target cell of BST 103. The Handoff Request message is based on the IS-2001-A standard. However, in accordance with the principles of the present invention, the Handoff Request message also contains information about the Supplemental Channel (SCH) configuration and about the Radio Link Protocol (RLP) configuration. The information about the SCH and RLP configurations is the same as the information contained in the Handoff Required message described above.

The circled numeral three (3) on an arrow from BST 103 to MSC 140 indicates the next step in the method of the present invention. If BST 103 can support the high speed packet data call, then BST 103 sends a Handoff Request Acknowledgement message to MSC 140 indicating that BST 103 is ready to accept the handoff. If BST 103 can not support the high speed packet data call, then BST 103 indicates this to MSC 140 by sending an appropriate Cause value in the message. The Handoff Request Acknowledgement message is based on the IS-2001-A standard.

The circled numeral four (4) on an arrow from BST 103 to PDSN2 320 indicates the next step in the method of the present invention. In order for the high speed packet data call to be handed over from BSS 101 to BST 103, BST 103 establishes a connection to PDSN2 320. BST 103 is then able to receive high speed packet data from PDSN2 320. The procedure for making this connection is described in the IS-2001-A standard. In the exemplary embodiment shown in FIG. 3 PDSN1 310 is a first PDSN in communication with BSS 101 and PDSN2 320 is a second PDSN in communication with BST 103. In an alternate embodiment (not shown) PDSN2 320 may be the same PDSN that the high speed packet data call is currently using. That is, in an alternate embodiment PDSN2 320 and PDSN1 310 may be the same PDSN.

The circled numeral five (5) on an arrow from MSC 140 to BSS 101 indicates the next step in the method of the present invention. MSC 140 indicates to BSS 101 that the high speed packet data call is now to be handed off to BST 103 MSC 140 sends this indication to BSS 101 with a Handoff Command message as described in the IS-2001-A standard.

The circled numeral six (6) on an arrow from BSS 101 to MS 112 indicates the next step in the method of the present invention. BSS 101 indicates to MS 112 that the high speed packet data call is to be transferred to the new target cell of BST 103. BSS 101 sends this indication to MS 112 using either a General Handoff Direction Message, or an Extended Handoff Direction Message, or a Universal Handoff Direction Message as described in the IS-2000 standard.

The high speed packet data call is transferred from BSS 101 by handing off the Supplemental Channel to BST 103. As previously described, BST 103 has already received SCH and RLP configuration information so that BST 103 knows the next RLP frame that is to be sent to MS 112 after the handoff of the Supplemental Channel to BST 103 has been completed. BST 103 receives the high speed packet data call on the Supplemental Channel starting at the next Radio Link Protocol (RLP) frame.

The circled numeral seven (7) on an arrow from BST 103 to MSC 140 indicates the next step in the method of the present invention. After BST 103 has successfully acquired MS 112, then BST 103 indicates to MSC 140 that the high speed packet data call has been successfully handed off to

BST 103. BSS 101 sends this indication to MSC 140 with a Handoff Complete message as described in the IS-2001-A standard.

The circled numeral eight (8) on an arrow from MSC 140 to BSS 101 indicates the next step in the method of the present invention. MSC 140 instructs BSS 101 to clear the high speed packet data call that has been handed off to BST 103. MSC 140 sends this instruction to BSS 101 with a Clear Command message as described in the IS-2001-A standard.

The present invention has major advantages over the prior art method described in the IS-2001-A standard. First, the present invention includes Supplemental Channel (SCH) configuration information in the Handoff Required message and in the Handoff Request message. The SCH information enables target base station BST 103 to determine in advance whether or not it can support the high speed packet data call. In prior art methods, the user does not know whether the call will be continued at the current high speed data rate until after the call has been handed over to target base station BST 103.

Second, providing the Supplemental Channel (SCH) configuration information to BST 103 allows the

Supplemental Channel (SCH) to be included in the hard handoff. This feature results in a performance gain because the Supplemental Channel (SCH) does not need to be reestablished on the target base station BST 103 after the handoff has been completed.

Third, the present invention includes Radio Link Protocol (RLP) configuration information in the Handoff Required message and in the Handoff Request message. This feature results in a performance gain because the Radio Link Protocol (RLP) connection does not need to be reestablished on the target base station BST 103 after the handoff has been completed.

Fourth, providing the Radio Link Protocol (RLP) configuration information to BST 103 allows BST 103 to resume transmission and reception of Radio Link Protocol (RLP) frames from the point that BSS 101 ceased transmitting and receiving. The capability to immediately resume transmission and reception of RLP frames results in a performance gain.

Fifth, there is no need to buffer RLP frames and spend time retransmitting the buffered RLP frames to mobile station 112. Therefore, the present invention improves performance by setting the Radio Link Protocol (RLP) in a non-retransmission mode.

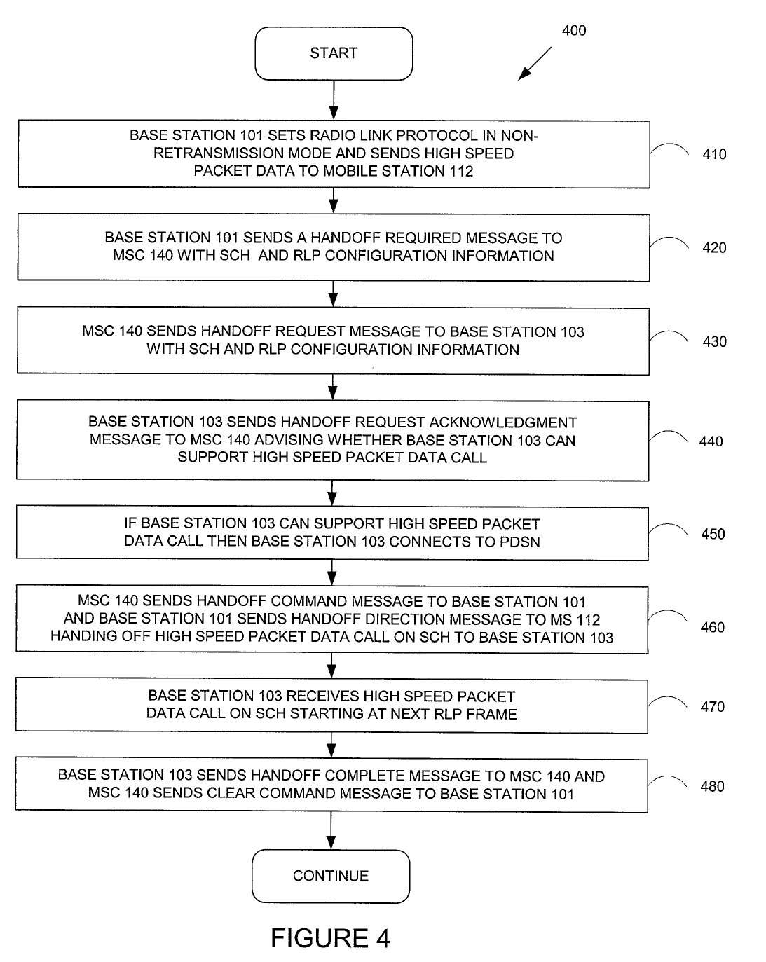

FIG. 4 illustrates a flowchart of an advantageous embodiment of a method of the present invention for providing a continuous high speed packet data handoff for a mobile station in a wireless network. The steps of the method are generally denoted with reference numeral 400. The source base station (BSS) 101 sets the Radio Link Protocol (RLP) in a non-retransmission mode and sends high speed packet data to mobile station (MS) 112 (step 410). Source base station (BSS) 101 determines that a handoff is needed and sends a Handoff Required message to mobile switching center (MSC) 140. The Handoff Required message contains Supplemental Channel (SCH) configuration information and Radio Link Protocol (RLP) configuration information (step 420).

Mobile switching center 140 sends a Handoff Request message to the target base station (BST) 103. The Handoff Request message contains the same Supplemental Channel (SCH) configuration information and Radio Link Protocol (RLP) configuration information that is contained in the Handoff Required message (step 430). This information allows the Supplemental Channel to be handed off to target base station (BST) 103.

Target base station (BST) 103 sends a Handoff Request Acknowledgement message to mobile switching center (MSC) 140 advising whether target base station (BST) 103 can support the high speed packet data call (step 440). If target base station (BST) 103 can support the high speed packet data call, then target base station (BST) 103 connects to an appropriate Packet Data Server Node (PDSN) (step 450).

Mobile switching center (MSC) 140 sends a Handoff Command message to source base station (BSS) 101 indicating that the high speed packet data call is now to be handed off to target base station (BST) 103. Source base station (BSS) 101 sends a Handoff Direction Message to mobile station (MS) 112 and hands off the high speed packet data call to target base station (BST) 103 on the Supplemental Channel (step 460).

Target base station (BST) 103 receives the high speed packet data call on the Supplemental Channel starting at the next Radio Link Protocol (RLP) frame (step 470). Target base station (BST) 103 then sends a Handoff Complete message to mobile switching center (MSC) 140 and mobile switching center (MSC) 140 sends a Clear Command message to source base station (BSS) 101 (step 480).

It is important to note that while the present invention has been described in the context of a fully functional network device, those skilled in the art will appreciate that the mechanism of the present invention is capable of being implemented and distributed in the form of a computer usable medium of instructions in a variety of forms, and that the present invention applies equally regardless of the particular type of signal bearing medium used. Examples include, but are not limited to: nonvolatile, hard-coded or programmable type mediums such as read only memories (ROMs) or erasable, electrically programmable read only memories (EEPROMs), recordable type mediums such as floppy disks, hard disk drives, and read/write (R/W) compact disc read only memories (CD-ROMs) or digital versatile discs (DVDs), and transmission type mediums such as digital and analog communications links.

Although the present invention has been described in detail, those skilled in the art will understand that various changes, substitutions, and alterations herein may be made without departing from the spirit and scope of the invention it its broadest form.

What is claimed is:

1. For use in a wireless network communications system comprising a mobile station, a source base station that is capable of communicating with said mobile station and with a target base station, and a target base station that is capable of communicating with said mobile station and with said source base station, an apparatus for handing off a high speed packet data call from said source base station to said target base station, said apparatus comprising:
a source base station that is capable of handing off a supplemental channel to a target base station; and
a target base station that is capable of receiving said supplemental channel when said supplemental channel is handed off from said source base station.

2. The apparatus as set forth in claim 1
wherein said source base station is capable of handing off a high speed packet data call on said supplemental channel to said target base station; and
wherein said target base station is capable of receiving said high speed packet data call on said supplemental channel handed off from said source base station.

3. The apparatus as set forth in claim 2 wherein said source base station is capable of activating a non-retransmission mode of a Radio Link Protocol (RLP) in said source base station and in said target base station.

4. The apparatus as set forth in claim 2
wherein said source base station comprises a packet data handoff controller that is capable of sending supplemental channel configuration information to said target base station; and
wherein said target base station comprises a packet data handoff controller that is capable of receiving said supplemental channel configuration information from said source base station.

5. The apparatus as set forth in claim 4 wherein said supplemental channel configuration information comprises one of: a supplemental channel forward data rate, a supplemental channel reverse data rate, a supplemental channel burst duration, and a supplemental channel radio configuration.

6. The apparatus as set forth in claim 4
wherein said source base station comprises a packet data handoff controller that is capable of sending Radio Link Protocol (RLP) configuration information to said target base station; and
wherein said target base station comprises a packet data handoff controller that is capable of receiving said Radio Link Protocol (RLP) configuration information from said source base station.

7. The apparatus as set forth in claim 6
wherein said source base station comprises a packet data handoff controller that is capable of handing off to said target base station a high speed packet data call on said supplemental channel starting at a selected Radio Link Protocol (RLP) frame identified in said Radio Link Protocol (RLP) configuration information; and
wherein said target base station comprises a packet data handoff controller that is capable of receiving from said source base station said high speed packet data call on said supplemental channel starting at said selected Radio Link Protocol (RLP) frame identified in said Radio Link Protocol (RLP) configuration information.

8. For use in a wireless network communications system comprising a mobile station, a source base station that is capable of communicating with said mobile station and with a target base station, and a target base station that is capable of communicating with said mobile station and with said source base station, a method for handing off a high speed packet data call from said source base station to said target base station, said method comprising the steps of:
providing a source base station that is capable of handing off a supplemental channel to a target base station;
providing a target base station that is capable of receiving said supplemental channel when said supplemental channel is handed off from said source base station; and
handing off a high speed packet data call from said source base station to said target base station on said supplemental channel.

9. The method as claimed in claim 8 further comprising the step of:
activating a non-retransmission mode of a Radio Link Protocol (RLP) in said source base station and in said target base station.

10. The method as claimed in claim 8 wherein said step of providing a source base station that is capable of handing off a supplemental channel to a target base station comprises the step of:
providing a source base station that comprises a packet data handoff controller that is capable of sending supplemental channel configuration information to said target base station.

11. The method as claimed in claim 10 wherein said supplemental channel configuration information comprises one of: a supplemental channel forward data rate, a supplemental channel reverse data rate, a supplemental channel burst duration, and a supplemental channel radio configuration.

12. The method as claimed in claim 8 wherein said step of providing a target base station that is capable of receiving said supplemental channel when said supplemental channel is handed off from said source base station comprises the step of:
providing a target base station that comprises a packet data handoff controller that is capable of receiving supplemental channel configuration information from said source base station.

13. The method as claimed in claim 12 wherein said supplemental channel configuration information comprises one of: a supplemental channel forward data rate, a supplemental channel reverse data rate, a supplemental channel burst duration, and a supplemental channel radio configuration.

14. For use in a wireless network communications system comprising a mobile station, a source base station that is capable of communicating with said mobile station and with a target base station, and a target base station that is capable of communicating with said mobile station and with said source base station, a method for handing off a high speed packet data call from said source base station to said target base station, said method comprising the steps of:
providing a source base station that is capable of handing off a supplemental channel to a target base station;
providing a target base station that is capable of receiving said supplemental channel when said supplemental channel is handed off from said source base station;
activating a non-retransmission mode of a Radio Link Protocol (RLP) in said source base station and in said target base station;
sending supplemental channel configuration information from said source base station to said target base station;
sending Radio Link Protocol (RLP) configuration information from said source base station to said target base station;
handing off a high speed packet data call from said source base station to said target base station on said supplemental channel; and
receiving in said target base station said high speed packet data call on said supplemental channel starting at a selected Radio Link Protocol (RLP) frame identified in said Radio Link Protocol (RLP) configuration information.

15. The method as claimed in claim 14 wherein said step of providing a source base station that is capable of handing off a supplemental channel to a target base station comprises the step of:
providing a source base station that comprises a packet data handoff controller that is capable of sending supplemental channel configuration information and Radio Link Protocol (RLP) configuration information to said target base station.

16. The method as claimed in claim 15 wherein said supplemental channel configuration information comprises one of: a supplemental channel forward data rate, a supplemental channel reverse data rate, a supplemental channel burst duration, and a supplemental channel radio configuration.

17. The method as claimed in claim 14 wherein said step of providing a target base station that is capable of receiving said supplemental channel when said supplemental channel is handed off from said source base station comprises the step of:
providing a target base station that comprises a packet data handoff controller that is capable of receiving supplemental channel configuration information and Radio Link Protocol (RLP) configuration information from said source base station.

18. The method as claimed in claim 17 wherein said supplemental channel configuration information comprises one of: a supplemental channel forward data rate, a supplemental channel reverse data rate, a supplemental channel burst duration, and a supplemental channel radio configuration.

19. The method as claimed in claim 14 further comprising the steps of:
sending a Handoff Required message from said source base station to a mobile switching center, wherein said Handoff Required message contains supplemental channel configuration information and Radio Link Protocol (RLP) configuration information;
sending a Handoff Request message from said mobile switching center to said target base station, wherein said Handoff Request message contains supplemental channel configuration information and Radio Link Protocol (RLP) configuration information;
sending a Handoff Request Acknowledgement message from said target base station to said mobile switching center indicating that said target base station can support said high speed packet data call;
connecting said target base station to a packet data server node to receive said high speed packet data call;
handing off said high speed packet data call from said source base station to said target base station on said supplemental channel; and
receiving in said target base station said high speed packet data call on said supplemental channel starting at a selected Radio Link Protocol (RLP) frame identified in said Radio Link Protocol (RLP) configuration information.

20. The method as claimed in claim 19 wherein said step of handing off said high speed packet data call from said source base station to said target base station on said supplemental channel comprises the steps of:
sending a Handoff Command message from said mobile switching center to said source base station to cause said high speed packet data call to be handed off to said target base station; and
sending a Handoff Direction message from said source base station to said mobile station to inform said mobile station of said handoff of said high speed packet data call to said target base station.
